(19) United States
(12) Patent Application Publication
(10) Pub. No.: US 2008/0210035 A1
(43) Pub. Date: Sep. 4, 2008

(54) Transmission

(75) Inventors: Jens Patzner, Postdam (DE); Frank Linke, Brandenburg (DE); Norbert Bork, Schonebeck (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 12/089,766

(22) PCT Filed: Nov. 22, 2006
(86) PCT No.: PCT/EP06/11154

§ 371 Date: Apr. 10, 2008

(30) Foreign Application Priority Data
Nov. 30, 2005 (DE) 10 2005 056 988.9

(51) Int. Cl. F16H 57/02

(52) U.S. Cl. 74/413; 74/606 R

(57) ABSTRACT

The invention concerns a transmission (2) with a transmission housing (1) and at least one idler gear (4) mounted by means of an idler gear shaft or idler gear axle (3), which meshes with a gear wheel (6) of a first transmission shaft (5) and a gear wheel (7) of a second transmission shaft (8), such that the idler gear shaft or idler gear axle (3) is supported at one end in or on a wall section of the transmission housing (1) by means of at least one bearing with a wrap-around contact angle of 360° and at the other end in a half-shell (11) fixed on a sidewall (9) of the transmission housing (1), or at both ends in respective half-shells (11) fixed on sidewalls (9) of the transmission housing (1).

To avoid increased wall thicknesses of the transmission housing (1) by simple and inexpensive means while ensuring sufficient support of load-carrying bearing points formed by a half-shell (11), the half-shell (11) is solidly associated with at least one rigid bracket (12) that bridges over a wall area of the transmission housing (1) in the circumferential direction thereof.

This application is a national stage completion of PCT/EP2006/011154 filed Nov. 22, 2006, which claims priority from German Application Serial No. 10 2005 056 988.9 filed Nov. 30, 2005.

### FIELD OF THE INVENTION

The invention concerns a transmission.

### BACKGROUND OF THE INVENTION

In the transmissions of motor vehicles the rotation direction change for reversing usually takes place by virtue of an idler gear mounted on an idler gear shaft in the transmission housing. The particular feature of the idler gear, compared with other gear wheels in the transmission, is that it meshes with two gear wheels, namely with an associated gear wheel on the main shaft or drive output shaft of the transmission and with an associated gear wheel on a drive input shaft or countershaft. The result is that very high forces act upon the bearings of the idler gear shaft.

Conventionally, the idler gear shaft is supported at one end in or on a sidewall of the transmission housing and at the other end in a half-shell fixed on a sidewall of the transmission housing. Likewise, the idler gear shaft can also be supported at both ends, in each case in a half-shell fixed on a sidewall of the transmission housing. The radial loads resulting from the mounting or support in these half-shells, are transferred into the transmission housing over a relatively small pressure angle range and largely at a point.

To avoid unacceptable displacements and above all fractures of the housing in the event of impact loads, it is proposed in DE 103 16 321 A1 that stiffening ribs should be arranged on the surfaces of the transmission housing that have bearing points that carry loads, to absorb the loads from the bearing points and spread them away from the area of the bearing points to areas of the transmission housing where there is high rigidity.

Against this background, the purpose of the invention is to provide a transmission developed further in relation to the prior art which, while avoiding larger wall thicknesses of the transmission housing, employs simple and inexpensive ways to ensure sufficient support of load-carrying bearing points formed by a half-shell.

### SUMMARY OF THE INVENTION

The invention concerns a transmission with a transmission housing and at least one idler gear mounted therein by way of an idler gear shaft or idler gear axle, which meshes with a gear wheel of a first transmission shaft. The idler gear shaft or idler gear axle is supported at one end in or on a wall section of the transmission housing by at least one bearing with a wrap-around, contact angle of 360° and, at the other end, in a half-shell fixed on a sidewall of the transmission housing or, at both ends in each case, in a half-shell fixed on a sidewall of the transmission housing.

According to the invention, it is additionally provided in this transmission that the half-shell supporting the idler gear shaft or idler gear axle and the idler gear is solidly associated with at least one rigid bracket that bridges over a wall area of the transmission housing in the circumferential direction thereof with at least one free end, such that to provide additional support, the at least one free end can be fixed onto the sidewall of the transmission housing.

In a particularly advantageous manner, this measure enables support and force transfer to be spread over a large area, even over parts of the transmission housing not subjected to loading, where there is no longer any need for the conventionally favored local wall thickening or molded ribs of the transmission housing.

As a further feature of the invention, the at least one bracket can be made integrally or in two pieces with the half-shell. The invention also provides the bracket and the half-shell as preferably cast components.

Furthermore, it is proposed that the bracket is made as a half-shell structure. Expediently, the half-shell and the bracket can be fixed to the sidewall of the transmission housing by concentric machining or construction by way of at least one radial bolted joint.

As an extension of the invention, it is further provided that in the bracket, at least one additional bearing is integrated for at least one shaft, such as a main shaft or countershaft of the transmission.

Finally in the context of the invention, the idler gear can consist of a reversing idler gear.

### BRIEF DESCRIPTION OF THE DRAWINGS

The invention will now be described, by way of example, with reference to the accompanying drawings in which:

FIG. 1 is a perspective lateral view of a transmission made according to the invention, with a main shaft, a countershaft and an idler gear shaft mounted in the transmission housing;

FIG. 2 is a transmission housing of the transmission, shown in FIG. 1, without shafts and gear wheels, and

FIG. 3 is an advantageous further development of the transmission in FIG. 1.

### DETAILED DESCRIPTION OF THE INVENTION

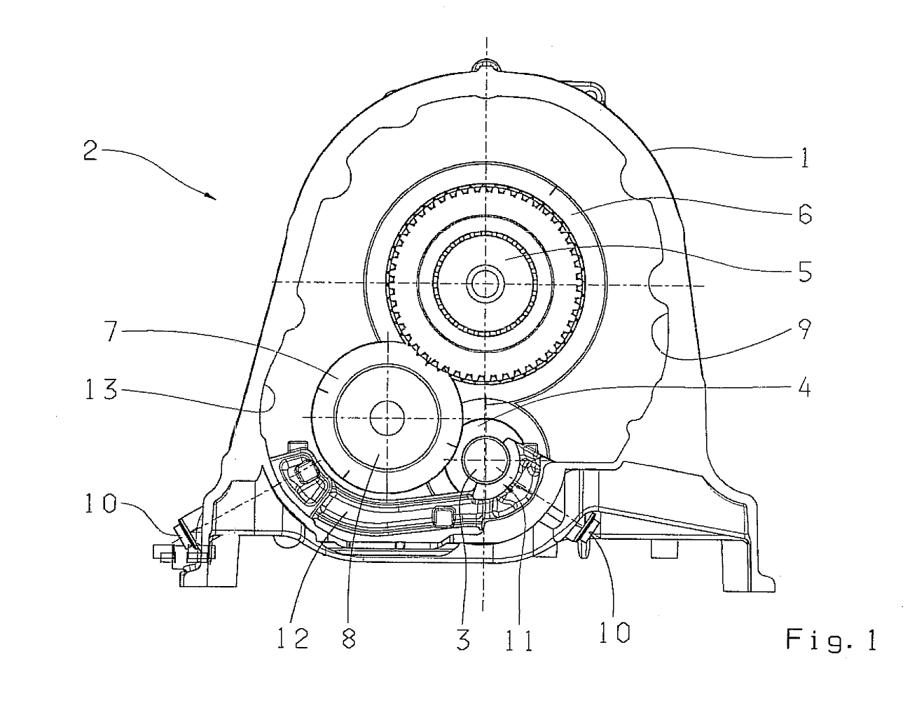

FIG. 1 shows a transmission housing 1 of a transmission 2, in particular for a motor vehicle, with an idler gear 4 mounted therein by way of an idler gear shaft 3. In the present case the idler gear 4 is a reversing idler gear and, in a manner known in itself, meshes both with a gear wheel 6 mounted on a main shaft 5 and with a gear wheel 7 mounted on a countershaft 8.

In a known way the idler gear shaft 3 is mounted at one end in or on a wall section (not shown in greater detail here) of the transmission housing 1, preferably by way of a roller bearing inset into the wall section, which supports the idler gear shaft 3 with a wrap-around context angle of 360°. At its other end, the idler gear shaft 3 is supported in a half-shell 11 fixed on a sidewall 9 of the transmission housing 1, preferably by way of a bolted joint 10. Likewise it is possible, and is included within the scope of the invention, for the idler gear shaft 3 to be supported at both ends in respective half-shells 11 fixed on sidewalls 9 of the transmission housing 1 (not illustrated here).

As regards the main shaft 5 and the countershaft 8, these can each be supported at both ends in or on wall sections at the ends by way of roller bearings with a wrap-around contact angle of 360° (not shown in more detail).

Now, to effectively overcome the problem of the clearly disadvantageous, relatively localized loading in the area of the at least one half-shell 11 that supports the idler gear shaft 3 and the idler gear 4, the half-shell 11 is solidly associated with at least one bracket 12, which bridges over a wall area of the transmission housing 1 in its circumferential direction.

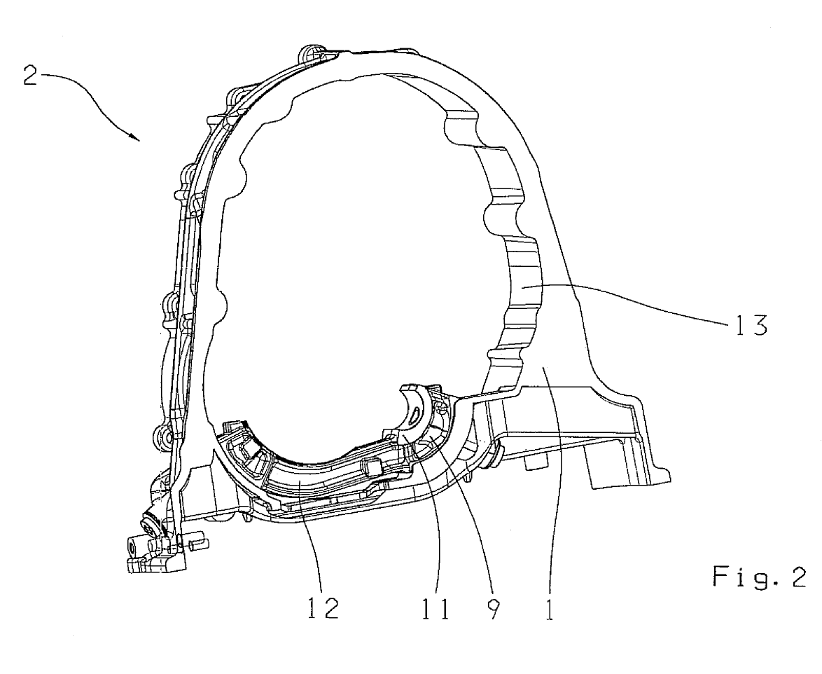

According to the preferred embodiment illustrated in FIG. 2, one end of the bracket 12 is solidly connected to the half-shell 11 that can be fixed on the sidewall 9 of the transmission housing 1, whereas the free end of the bracket 12 can be fixed on an opposite sidewall 13 of the transmission housing 1 in the circumferential direction. For this too, a bolted joint 10 is provided.

This measure provides additional support for idler gear shafts 3 where, in a particularly advantageous manner, an area of the transmission housing 1 can be bridged which, owing to design-related boundary conditions, perhaps such as the absence of structural space for greater housing wall thicknesses or stiffening means, could not otherwise be used to support the half-shell 11.

However, the invention is not limited to the preferred embodiment described. For example, it is also conceivable that the loading support is provided mainly by the bracket 12 in that the latter has two free ends that can be fixed on the sidewalls 9, 13 and the half-shell 11 is connected solidly to the bracket 12 in any desired area between the free ends thereof, without itself being solidly connected directly to the transmission housing 1 (not illustrated further).

The bracket 12 is preferably made integrally with the half-shell 11 as a cast component. Obviously however it can also be indicated and is, therefore, within the scope of the invention, that the two components are made separately and then assembled together and fixed on the sidewalls 9, 13 in such a manner that in the sense of the invention, force is transferred from the half-shell 11 to the one and the other sidewalls 9, 13 of the transmission housing 1 via the bracket 12.

As FIGS. 1 and 2 also show, the bracket 12 is formed as a half-shell structure which mates as closely as possible with the inside contour of the transmission housing 1 so that the structural space required for the bracket 12 is minimized.

Expediently, the half-shell 11 and the bracket 12 are fixed on the respective sidewalls 9, 13 of the transmission housing 1 by concentric machining or construction by way of radial bolted joints, where the force transfer into the sidewalls 9, 13 is optimized.

However, the bracket 12 is not only suitable for supporting the idler gear shaft 3 of an idler gear 4, in the present case a reversing idler gear, but can also be used for other supporting functions.

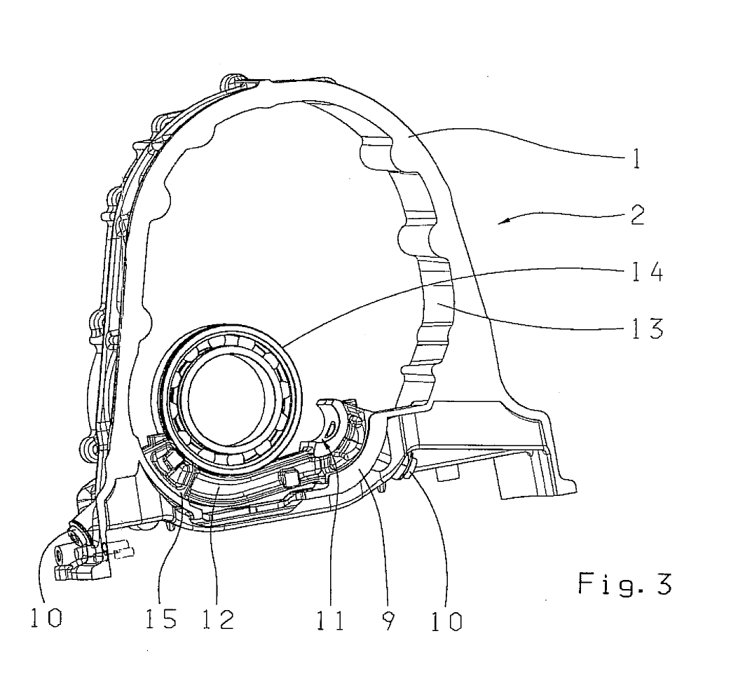

For example, at least one additional bearing 14 for at least one shaft, which can be the main shaft 5 or the countershaft 8, can be integrated in the bracket 12. FIG. 3 shows such a structure of the bracket 12 in which, besides a half-shell 11, it is also firmly associated with the bearing 14 to hold the countershaft 8. This enables an additional support bearing for a shaft to be formed in order to prevent unacceptable bending thereof. In such cases, an additional support element 15 can be associated with the bracket 12, which compensates any gap between the bracket 12 and the inside contour of the transmission housing 1 in the area of the bearing 14 (FIG. 3).

When a rotating idler gear shaft is used, this is supported radially at both ends by roller bearings. When an idler gear axle is used, on which the idler gear is mounted to rotate, the idler gear axle is rotationally fixed at both ends.

### REFERENCE NUMERALS

1 transmission housing
2 transmission
3 idler gear shaft or idler gear axle
4 idler gear
5 main shaft
6 gear wheel (main shaft 5)
7 gear wheel (countershaft 8)
8 countershaft, transmission shaft
9 sidewall of the transmission housing
10 bolted joint
11 half-shell
12 bracket
13 sidewall of the transmission housing
14 bearing
15 support element

1-7. (canceled)

8. A transmission (2) with a transmission housing (1) and at least one idler gear (4) mounted on one of an idler gear shaft and an idler gear axle (3), which meshes with a gear wheel (6) of a first transmission shaft (5) and a gear wheel (7) of a second transmission shaft (8) such that the one of the idler gear shaft and the idler gear axle (3) is one of supported at one end by a wall section of the transmission housing (1) via at least one bearing with a wrap-around contact angle of 360° and at another end in a half-shell (11) fixed on a sidewall (9) of the transmission housing (1), and at both ends in respective half-shells (11) fixed on the sidewalls (9) of the transmission housing (1), the at least one half-shell (11) that supports the idler gear shaft (3) and the idler gear (4) is solidly associated with at least one rigid bracket (12) that bridges over a wall area of the transmission housing (1) in a circumferential direction thereof with at least one free end, and the at least one free end is fixed on the sidewall (9) of the transmission housing (1) to provide additional support.

9. The transmission according to claim 8, wherein the at least one bracket (12) is one of integral with the half-shell (11) and made as two pieces.

10. The transmission according to claim 8, wherein the bracket (12) and half-shell (11) are cast components.

11. The transmission according to claim 8, wherein the bracket (12) is a half-shell structure.

12. The transmission according to claim 8, wherein by one of concentric machining and construction, the half-shell (11) and the bracket (12) are fixed on the sidewalls (9, 10) of the transmission housing (1) by at least one radial bolted joint (10).

13. The transmission according to claim 8, wherein at least one additional bearing (14) for at least one the first transmission shaft (5) and the second transmission shaft (8) is integrated in the bracket (12).

14. The transmission according to claim 8, wherein the idler gear (4) is a reversing idler gear.

15. A transmission (2) comprising:
an idler gear (4) supported by an idler gear shaft (3),
a first gear wheel (6) rotatably supported by a first transmission shaft (5) and a second gear wheel (7) rotatably supported by a second transmission shaft (8), the idler gear (4) engaging both the first gear wheel (6) and the second gear wheel (7) and having a first end and an opposed second end;
a bearing supported by a first wall of a transmission housing (1), the bearing rotatably supports the first end of the idler gear shaft (3) with an angle of wrap of 360° and the second end of the idler gear shaft (3) is supported by a half-shell (11); and
a bracket (12) being fixed to and spans a portion of a second wall of the transmission housing (1), the bracket (12) communicating with and supporting the half-shell (11) such that the idler gear shaft (3) is supported by the half-shell (11), which is supported by the bracket (12), which is supported by the second wall of the transmission housing (1).

16. The transmission according to claim 15, wherein the bracket (12) and the half-shell (11) are integral with one another.

17. The transmission according to claim 15, wherein the bracket (12) and the half-shell (11) are cast components.

18. The transmission according to claim 15, wherein the bracket (12) a half-shell structure.

19. The transmission according to claim 15, wherein the half-shell (11) and the bracket (12) are fixed on the second wall of the transmission housing (1) by at least one radial bolted joint (10).

20. The transmission according to claim 15, wherein at least one additional bearing (14) for supporting at least one of the first transmission shaft (5) and the second transmission shaft (8) is integrated in the bracket (12).

21. The transmission according to claim 15, wherein the idler gear (4) is a reversing idler gear.
